(19) United States
(12) Patent Application Publication
(10) Pub. No.: US 2022/0322642 A1
(43) Pub. Date: Oct. 13, 2022

(54) Squirrel Proof Bird Feeder

(71) Applicant: Woodstream Corporation, Lancaster, PA (US)

(72) Inventor: Steven Lorraine, Lancaster, PA (US)

(73) Assignee: Woodstream Corporation, Lancaster, PA (US)

(21) Appl. No.: 17/229,116

(22) Filed: Apr. 13, 2021

(51) Int. Cl. A01K 39/01

(52) U.S. Cl. CPC A01K 39/0113; A01K 39/0106

(57) ABSTRACT

A bird feeder comprises an inner housing including a seed reservoir having at least one feed port defined therethrough, and an inner base supporting the seed reservoir. An outer housing of the feeder is moveably mounted to the inner housing, and includes a reservoir cover arranged over the seed reservoir and defining at least one feed opening. A top cover of the outer housing receives a portion of the inner housing, and an outer base of the outer housing supports the reservoir cover. The outer housing is moveable relative to the inner housing between a first position and a second position. A compression spring is operatively connected between the inner base and the outer base for biasing the outer housing into the first position relative to the inner housing.

### FIELD OF THE INVENTION

The present disclosure relates to bird feeders, and more particularly, to an improved bird feeder which prevents undesired animals from accessing feed retained within the feeder.

### BACKGROUND

Bird feeders are often subject to attack by animals, such as squirrels, attempting to gain access to their stored feed or bird seed. In addition to scaring away would-be feeding birds, squirrels or other animals who gain access to the feeder may consume large amounts of seed. Likewise, attempts to gain access to the seed by these animals often results in excess seed spillage, creating both waste and mess, and risks temporary or permanent damage to the feeder due to their relatively large weight and aggressive nature.

Numerous examples of so-called squirrel-proof feeders are found in the prior art. These designs, however, have proven inadequate and/or are overly complicated and thus not cost effective. For example, some feeders utilize moveable covers which selectively close or block feed ports of the feeder in response to excess weight placed on a feeding perch of the feeder. Thus, the feeder requires an attacking animal's weight to be placed onto a lower portion or the perch thereof in order to engage mechanism which closes the feeding ports. However, squirrels commonly attack feeders from above, wherein access to the feed ports may be gained without bearing weight on the feeder's lower portions. Likewise, other designs utilize closing mechanisms which occupy excessive space within the feeder and/or lack access for repair or replacement.

Accordingly, there is a need for an improved squirrel or animal proof bird feeder which resists attacks from all directions, while remaining cost effective to manufacture and easy to maintain.

### SUMMARY

A bird feeder according to an embodiment of the present disclosure comprises an inner housing including a seed reservoir having at least one feed port defined therethrough providing access to seed contained within the reservoir, and an inner base supporting the seed reservoir. The feeder further comprises an outer housing moveably mounted to the inner housing, including a reservoir cover arranged over the seed reservoir and defining at least one feed opening. The outer housing is moveable relative to the inner housing between a first position, wherein the at least one feed port and the at least one feed opening are aligned, and a second position, wherein the at least one feed port and the at least one feed opening are not aligned and the outer housing covers the feed port. The outer housing further comprises a top cover arranged over and receiving a portion of the inner housing, and an outer base supporting the reservoir cover. A compression spring is operatively connected between the inner base and the outer base for biasing the outer housing into the first position relative to the inner housing, wherein the application of a predetermined force on the outer housing is operative to bias the outer housing into the second position against an elastic return force of the compression spring.

A bird feeder according to another embodiment of the present disclosure comprises an inner housing having a seed reservoir. The seed reservoir defines at least one feed portion in communication with an interior of the reservoir holding a quantity of seed. An outer housing is arranged over the inner housing and includes at least one feed opening. The outer housing is moveable relative to the inner housing between a first position, wherein the at least one feed port and the at least one feed opening are aligned, and a second position, wherein the at least one feed port and the at least one feed opening are not aligned. An elastic return assembly is arranged beneath the seed reservoir and biases the outer housing into the first position relative to the inner housing.

### BRIEF DESCRIPTION OF THE DRAWINGS

The invention will now be described by way of example with reference to the accompanying figures, of which:

FIG. 1 is front perspective view of bird feeder according to an embodiment of the present disclosure in an open or feeding position or state;

FIG. 2 is a front perspective view of the bird feeder of FIG. 1 in a closed or blocked position;

FIG. 3 is a partial side perspective view of an inner housing of the feeder according to embodiments of the present disclosure;

FIG. 4 is a partial side perspective view of an outer housing of the feeder according to embodiments of the present disclosure;

FIG. 5 is a partial side perspective view of the inner and outer housings of FIGS. 3 and 4 in the closed position of the feeder;

FIG. 6 is a top perspective view of the feeder of FIG. 1 in the open position with a top cover or lid thereof removed;

FIG. 7 is a top perspective view of the feeder of FIG. 2 in the closed position with the top cover removed;

FIG. 8 is a bottom perspective view of the top cover according to embodiments of the present disclosure;

FIG. 9 is a bottom perspective view of the feeder in the open position;

FIG. 10 is a bottom perspective view of the feeder in the closed position;

FIG. 11 is a bottom view of the feeder according to embodiments of the present disclosure in a partially disassembled state in the open position; and

FIG. 12 is a partial bottom view of the feeder according to embodiments of the present disclosure in another partially disassembled state in the open position.

### DETAILED DESCRIPTION OF THE EMBODIMENT(S)

Exemplary embodiments of the invention will be described hereinafter in detail with reference to the attached drawings, wherein like reference numerals refer to like elements. The invention may, however, be embodied in many different forms and should not be construed as being limited to the embodiments set forth herein; rather, these embodiments are provided so that the present disclosure will be thorough and complete, and will fully convey the concept of the disclosure to those skilled in the art.

Embodiments of the present disclosure include a feeder, such as a bird feeder, adapted to resist attacks from all angles, including from the sides, top and/or bottom of the feeder. The feeder includes an inner housing and an outer housing moveably mounted to the inner housing. The inner housing includes a seed reservoir having at least one feed port therethrough for providing access to the seed, and an inner base defining a bottom of the seed reservoir. The outer housing includes a reservoir cover arranged generally around the inner housing, a top cover arranged over the top of the inner housing, and an outer base attached to a bottom of the reservoir cover. The reservoir cover includes feed openings corresponding to the feed ports of the seed reservoir. The outer housing, including each of the top cover, the reservoir cover and the outer base, is moveable relative to the inner housing between a first or open position, wherein the feed openings and feed ports are aligned, and a second or closed position, wherein the feed openings and feed ports are not aligned and the outer housing covers the feed ports. In this way, in response to the application of a predetermined force placed on any portion of the outer housing, including onto the top cover alone, the feeder is biased into the closed position or state.

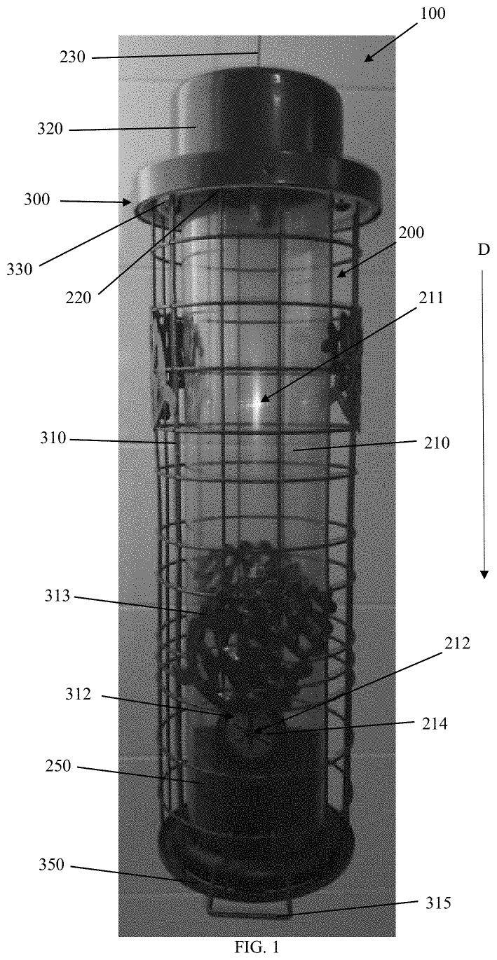

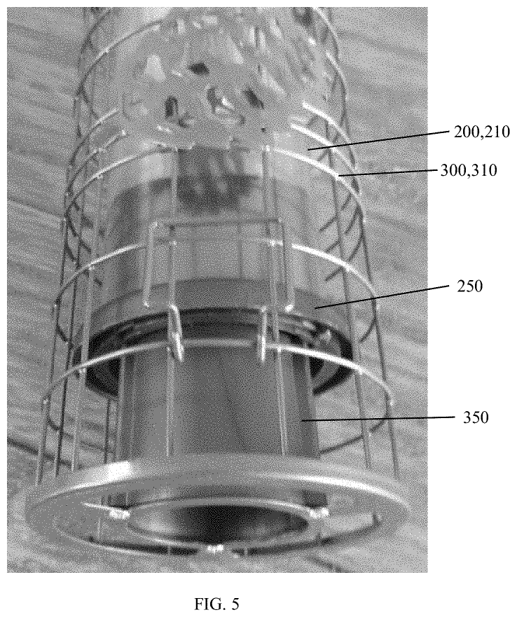

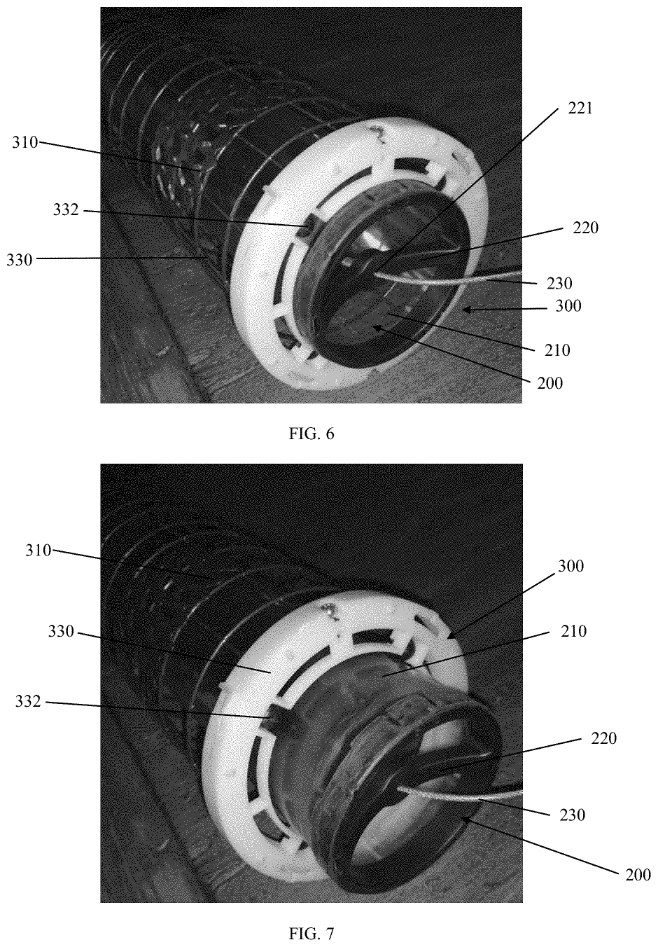

Referring to FIG. 1, a feeder 100 according to an embodiment of the present disclosure is shown in an open or feeding position or state, wherein one or more feed ports 214 are exposed, providing access to feed (not shown) held within the feeder. More specifically, the feeder 100 includes a fixed subassembly or inner housing 200 and a moveable subassembly or outer housing 300 arranged in a telescoping manner over the inner housing. The inner housing 200 includes a hollow intermediate section or seed reservoir 210 defining a seed space 211, a feeder support 220 arranged on a first end of the seed reservoir (see FIG. 6), and an inner base or bottom end 250 fitted to a second end of the seed reservoir, opposite the first end. The feeder 100 further comprises a hanging wire 230 including an end fixable to the feeder support 220, and a free end attachable to an external support structure, for hanging the feeder by the inner housing 200. The inner housing 200 defines a fixed subassembly in that, with the feeder 100 suspended via the wire 230, it is generally fixed in position with respect to the wire under the force of gravity. In response to an animal acting on a surface thereof, however, the outer housing 300 is moveable relative to the inner housing 200.

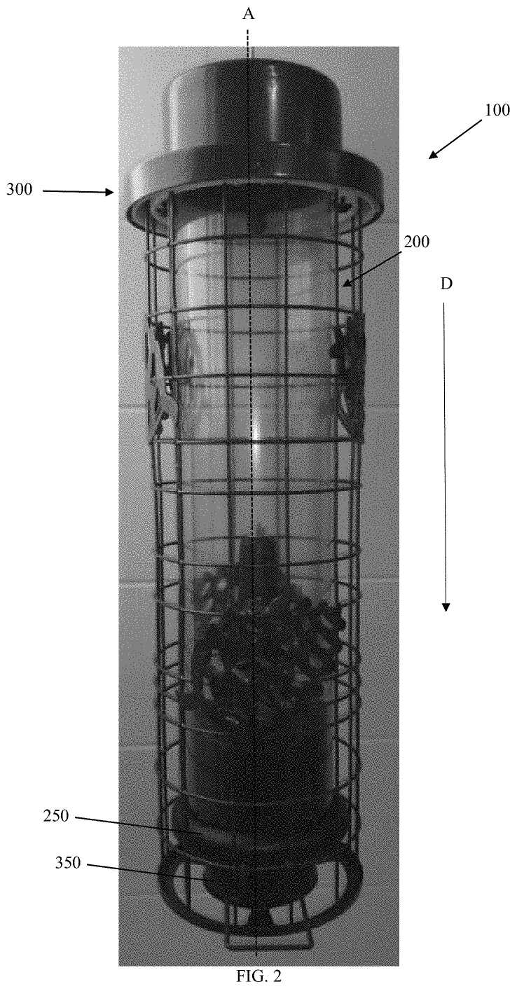

More specifically, the moveable subassembly or outer housing 300 includes an intermediate portion or reservoir cover 310, a feeder top cover or lid 320 fixedly attached to the reservoir cover, a support guide 330, and an outer base or bottom end 350 fixed to the reservoir cover and sized to be moveably received within an underside of the inner base 250. The outer housing 300 is moveable relative to the inner housing 200 in the indicated direction D from the open position of the feeder 100 illustrated in FIG. 1, to the closed position illustrated in FIG. 2, wherein the reservoir cover 310 blocks the feed port 214, preventing access to the seed space 211 therethrough. As shown, the outer housing 300 is moveable relative to the inner housing 200 along the working or vertical axis A, which may be a central axis of the feeder 100.

As will be set forth in greater detail herein, the outer housing 300 is held in the open position via the application of a force generated by an elastic biasing arrangement. In response to the application of a sufficient opposite force on any portion of the outer housing 300, including on the top cover 320 or feeding pedestals 315 of the reservoir cover 310, the outer housing is biased downward, against the return force of an elastic element of the biasing arrangement. In this way, in response to an animal attack on nearly any exterior surface of the feeder, the outer housing 300 of the feeder will be biased into the closed position, blocking access to the seed held within the seed space 211. Likewise, when the biasing force is removed (e.g., when an animal releases or dismounts the feeder), the outer housing 300 will return to the open position shown in FIG. 1 under a return force applied by the elastic element, wherein the feed port(s) 214 are exposed and normal feeding can be resumed.

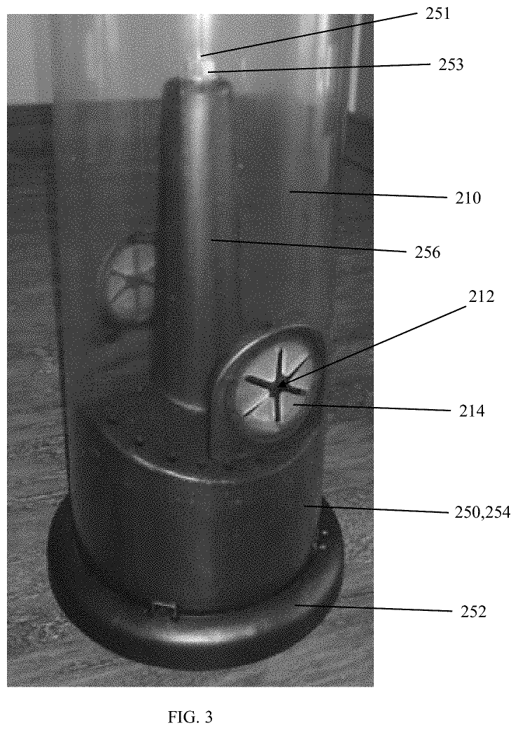

Still referring to FIGS. 1 and 2, as well as to FIG. 3, the exemplary seed reservoir 210 comprises a hollow cylindrical housing, such as a transparent polymer housing, and defines the feed space 211 for holding a volume of feed, such as bird seed. The reservoir 210 comprises one or more (e.g., two in the exemplary embodiment) openings 212 formed therethrough. The openings 212 may be fitted with, or covered by, the feed ports 214. The feed ports 214 include, for example, flexible fingers for preventing seed from falling out of the reservoir 210, while permitting a feeding bird to access the seed therethrough.

The inner base 250 may be fitted to a lower end of the seed reservoir 210, or formed integrally therewith, and generally comprises an outer flange 252, a first cylindrical body portion 254 sized for fixed insertion within the seed reservoir 210, and a generally conical or tapering protruding end portion 256. The inner base 250, including the cylindrical body 254 and conical end portion 256, is generally hollow in nature and configured to slidably receive the second or outer base 350 therein in an assembled state of the feeder 100. A fastener, such as a threaded rod 251 is secured to a free end of the conical end portion 256, and extends into the hollow interior thereof. The rod 251 may be fixed to the inner base 250 via one or more nuts 253, for example, two nuts arranged on either side of the top of the conical end portion 256.

Referring now to FIGS. 1 and 2, as well as to FIG. 4, the reservoir cover 310 may comprise a generally cylindrical wire mesh shield defined by a plurality of horizontally and vertically extending wire segments. The reservoir cover 310, and more specifically, the mesh pattern thereof, defines openings 312 adapted to align with the feed ports 214 and openings 212 of the seed reservoir 210 in the first position of the feeder 100. The reservoir cover 310 further defines blocking sections or port covers 313, embodied as camouflaging and/or decorative elements, positioned over the mesh for covering the feed ports 214 in the second position of the feeder 100. Feeding perches 315 may be fixed or otherwise attached to the reservoir cover 310, and provide resting surfaces for birds while feeding. In one embodiment, each perch 315 is hingedly attached to the reservoir cover 310.

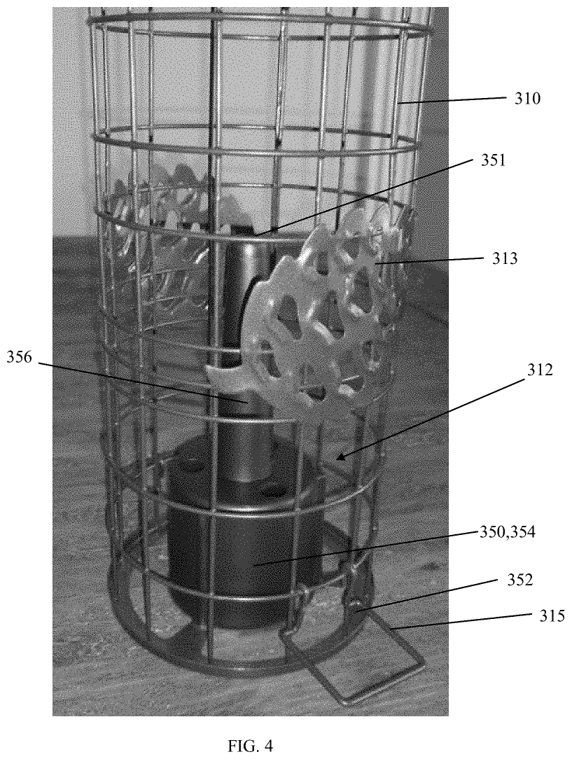

Similar to the inner base 250, the outer base 350 includes a mounting flange 352, which may be formed integrally with or attached to the reservoir cover 310, a hollow cylindrical body 354 fixable to the mounting flange, and a conical or tapering end portion 356 sized to be slidably received within the hollow interior of the inner base 250, as shown in FIGS. 5, 9 and 10. The conical end portion 356 defines an aperture 351 coaxial with and receiving the threaded rod 251 therethrough in an assembled state of the feeder 100. As can be visualized in FIGS. 5, 9 and 10, the telescoping arrangement of the respective tapered end portions 256,356 provides a locating function between the inner and outer housings 200,300, supporting and guiding their respective movement along the axis A. In particularly, due to their corresponding taper profiles, the inner and outer bases 250,350 ensure the inner and outer housings 200,300 converge into coaxially alignment as the feeder 100 is moved from the second position to the first position.

Referring now to FIGS. 6 and 7, the outer housing 300 and the inner housing 200 are shown in the first and second positions, respectively. The reservoir cover 310 is fixedly attached to a rolling support guide 330. The rolling support guide 330 comprises a plurality of roller bearings 332 arranged radially about an interior opening thereof. The bearings 332 are configured to rotatably or slidably engage with the exterior surface of the seed reservoir 210 received within the interior opening. In this way, the rolling support guide 330 acts to guide the axial or telescoping movement of the reservoir cover 310 over seed reservoir 210 between the first and second positions of the feeder. This arrangement ensures the outer housing 300 remains centered relative to the inner housing 200, despite potentially high and axially offset forces acting therein by an attacking animal. Still referring to FIGS. 6 and 7, the feeder support 220 is fixed to a first or top end of the seed reservoir 210 and includes a mounting hole 221 centered along the axis A (see FIG. 2) for receiving an end of the hanging wire 230.

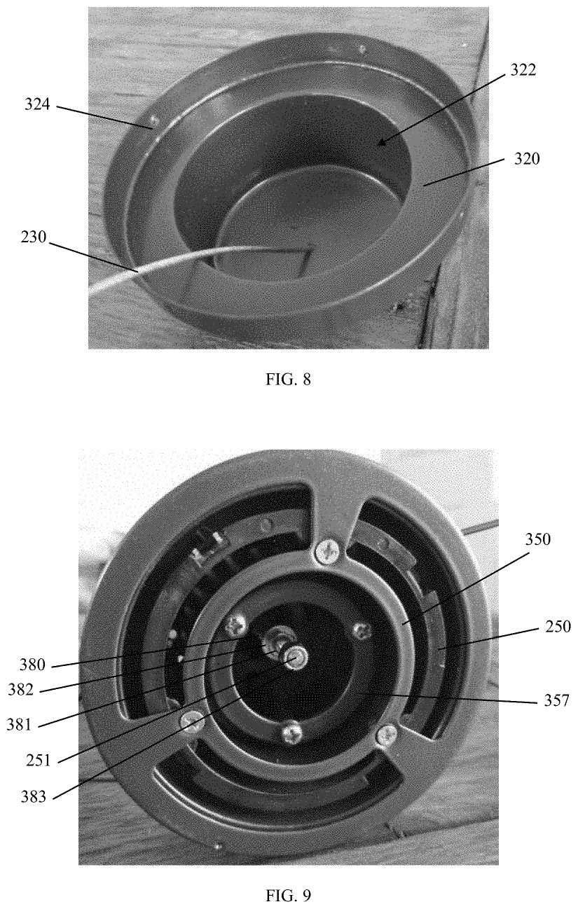

As shown in FIG. 8, an underside of the top cover 320 defines a hollow interior chamber 322 into which the first end of the seed reservoir 210 and feeder support 220 are received as the outer housing 300, including the top cover 320, are biased downwardly over the inner housing 200 toward the second position of the feeder. A flange 324 of the top cover 320 is adapted to be selectively fixable to the roller support guide 330. In this way, the top cover 320 may be removed in order to fill the seed reservoir 210 or otherwise maintain the feeder during use.

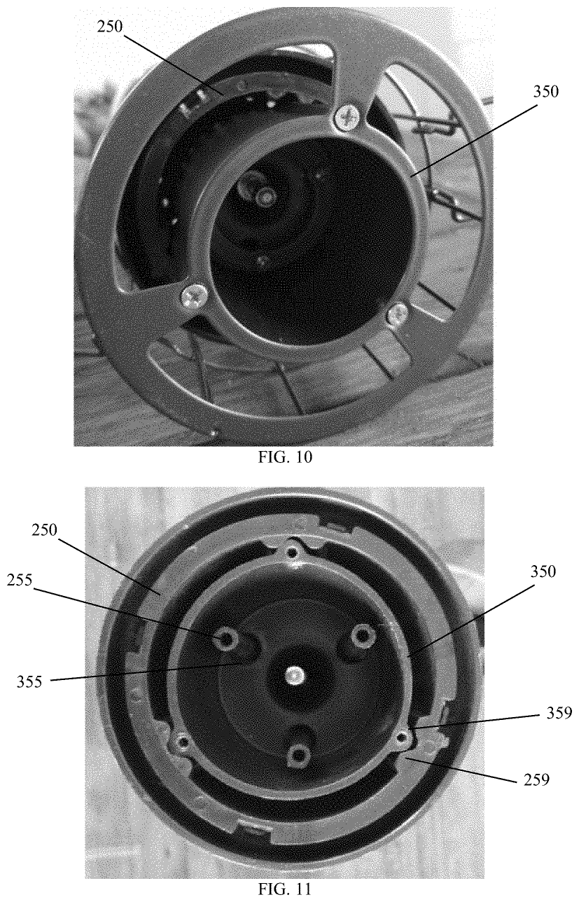

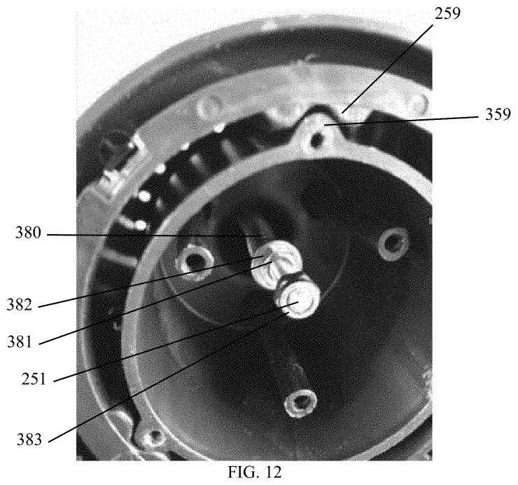

FIGS. 9 and 10 illustrate a bottom of the feeder 100 in the first and second positions, respectively. As shown, an elastic element, such as a compression spring 380, is arranged on the threaded rod 251, and secured thereon by at least one pre-loading feature, such as a threaded nut 381 and spring seat or washer 382. A self-locking nut 383 may also be secured to an end of the rod 251, ensuring the preloading nut 381 remains on the threaded rod in the event of unintended loosening over time. See also FIG. 12. With particular reference to FIG. 9, threading the preloading nut 381 upwards along the threaded rod 251 preloads the compression spring 380, biasing the outer base 350 upwards and against the inner base 250, thus holding the feeder 100 into the first or open position as shown and described herein. Referring specifically to FIG. 10, downward force (relative to the orientation of the feeder shown in FIGS. 1 and 2) on any portion of the outer housing 300 acts to draw the outer base 350 axially at least partially out of the inner base 250, compressing the spring 380 as the feeder 100 is moved into the second or closed position (see also FIG. 2).

Referring now to FIGS. 11 and 12, the inner base 250 comprises a plurality of bosses 255 extending therefrom in the axial direction. Likewise, the outer base 350 includes a plurality of apertures 355 corresponding in location to and receiving the bosses 255 with the second base installed within the first base. As shown in FIG. 9, an annular plate 357 may be fastened to the free ends of the bosses 255 and forms a mechanical stop, capturing the outer base 350 within the inner base 250, and limiting its motion along the axis A. The bosses 255 and apertures 355 further act to guide the movement of the outer base 350 relative to the inner base 250 along the axis A, as well as fix the rotational or radial position of the first housing 200 relative to the second housing 300, ensuring the proper alignment of the feed ports and covers thereof. Further, an inwardly-facing wall of the cylindrical body 254 defines a plurality of guide channels or slots 259 arranged radially thereabout. The slots 259 are configured to slidably receive a plurality of corresponding protruding guide features 359 formed on an exterior of the outer base 350. Like the bosses 255, these corresponding guide features further act to ensure alignment between the first and second housings 200,300 as they are moved relative to one another between the first and second positions, including preventing their relative rotation about the axis A.

As shown in the figures, the entirety of the elastic biasing arrangement, including the spring 380 and associated fasteners, is arranged with the hollow interior space defined in the bottoms of the inner and outer housings 250,350. However, the arrangement is exposed from an underside of the feeder 100, allowing for easy access for adjustment or replacement, while protecting the assembly from damage and from the elements. This arrangement also minimizes feeder size by limiting the placement of the spring element to the bottom of the feeder, rather than extending through the feed reservoir of the feeder and reducing available seed storage space, as is found in prior art designs.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range.

Also, the indefinite articles “a” and “an” preceding an element or component of the invention are intended to be nonrestrictive regarding the number of instances, that is, occurrences of the element or component. Therefore “a” or “an” should be read to include one or at least one, and the singular word form of the element or component also includes the plural unless the number is obviously meant to be singular.

The term “invention” or “present invention” as used herein is a non-limiting term and is not intended to refer to any single embodiment of the particular invention but encompasses all possible embodiments as described in the application.

What is claimed is:

1. A bird feeder comprising:
an inner housing, including:
a seed reservoir having at least one feed port defined therethrough for providing access to seed contained within the seed reservoir; and
an inner base supporting the seed reservoir;
an outer housing moveably mounted to the inner housing, including:
a reservoir cover arranged over the seed reservoir and defining at least one feed opening, the outer housing moveable relative to the inner housing along an axis of the feeder between a first position, wherein the at least one feed port and the at least one feed opening are aligned, and a second position, wherein the at least one feed port and the at least one feed opening are not aligned and the outer housing covers the feed port;
a top cover arranged over and receiving a portion of the inner housing; and
an outer base supporting the reservoir cover; and
a compression spring operatively connected to the inner housing and the outer housing for biasing the outer housing into the first position relative to the inner housing, wherein the application of a predetermined force on the outer housing is operative to bias the outer housing into the second position against an elastic return force of the compression spring.

2. The bird feeder of claim 1, wherein the top cover defines a recess slidably receiving a first end of the inner housing, the inner housing moveable within the recess in response to the movement of the outer housing between the first position and the second position.

3. The bird feeder of claim 1, wherein the outer housing is moveable in a telescoping manner over the inner housing.

4. The bird feeder of claim 3, wherein the outer housing further includes a support guide including at least one roller bearing engaged with a surface of the inner housing for maintaining alignment of the outer housing relative to the inner housing as the outer housing moves between the first and second positions.

5. The bird feeder of claim 1, wherein the inner base receives at least a portion of the outer base in the first position of the outer housing.

6. The bird feeder of claim 5, wherein the inner base and the outer base comprise complementary and telescoping tapered bodies for guiding the movement of the outer housing between the first and second positions.

7. The bird feeder of claim 6, wherein the tapered bodies of the inner and outer housings extend partially into the seed reservoir from a bottom end thereof.

8. The bird feeder of claim 7, wherein the inner base defines a plurality of bosses protruding in a direction of the axis of the feeder, and the outer base comprises a plurality of apertures receiving the protruding bosses therethrough, the inner housing further comprising a mechanical stop fixed to free ends of the protruding bosses for capturing the outer base within the inner base.

9. The bird feeder of claim 6, wherein the compression spring is arranged within a spring space defined by and within the inner and outer bases.

10. The bird feeder of claim 9, wherein at least a portion of the compression spring extends into the tapered bodies of the inner and outer bases.

11. The bird feeder of claim 1, wherein the inner housing includes a feeder support fixedly attached to the seed reservoir for suspending the feeder in a substantially vertical orientation.

12. The bird feeder of claim 1, wherein the compression spring is arranged below the inner base and the outer base.

13. The bird feeder of claim 12, wherein the compression spring has a first end fixed relative to the inner base and a second moveable end engaging with the outer base for biasing the outer housing into the first position relative to the inner housing.

14. The bird feeder of claim 13, wherein the inner base includes a spring support extending into the outer base, the first end of the compression spring is arranged on the spring support and the second moveable end of the compression spring engages with an underside of the outer base for biasing the outer housing into the first position relative to the inner housing.

15. The bird feeder of claim 14, wherein the spring support comprises a preloading element for selectively compressing the compression spring with the outer housing in the first position relative to the inner housing.

16. The bird feeder of claim 15, wherein the spring support comprises a threaded rod and the preloading element comprises a threaded nut.

17. A bird feeder comprising:
an inner housing having a seed reservoir and at least one feed port for accessing an interior of the seed reservoir;
an outer housing arranged over the inner housing and including at least one feed opening, the outer housing moveable relative to the inner housing between a first position, wherein the at least one feed port and the at least one feed opening are aligned, and a second position, wherein the at least one feed port and the at least one feed opening are not aligned; and
an elastic return assembly arranged below the seed reservoir and biasing the outer housing into the first position relative to the inner housing.

18. The bird feeder of claim 17, wherein the seed reservoir is supported on an inner base of the inner housing, and wherein the outer housing includes a reservoir cover supported on an outer base, the elastic return assembly includes a compression spring arranged below the inner base and the outer base and operatively connected to the inner housing and the outer housing for biasing the outer housing in an upward direction and into the first position relative to the inner housing, wherein the application of a predetermined force on the outer housing is operative to bias the outer housing into the second position against an elastic return force of the compression spring.

19. The bird feeder of claim 18, wherein the inner base includes a spring support extending through the outer base in a vertical direction, the compression spring is arranged between the spring support and an underside of the outer base.

20. The bird feeder of claim 17, wherein the outer housing includes top cover defining a recess slidably receiving a portion of the inner housing, the inner housing moveable within the recess in response to the movement of the outer housing between the first position and the second position.
